(19) United States
(12) Patent Application Publication
(10) Pub. No.: US 2008/0250483 A1
(43) Pub. Date: Oct. 9, 2008

(54) Method and System for Authenticating Products Using Serial Numbers and Passwords Over Communication Network

(76) Inventor: Hang Kyung Lee, Gyeonggi-do (KR)

Correspondence Address: ADAM K. SACHAROFF;MUCH SHELIST FREED DENENBERG AMENT&RUBENSTEIN,PC, 191 N. WACKER DRIVE, SUITE 1800, CHICAGO, IL, 60606-1615, US

(21) Appl. No.: 12/088,105

(22) PCT Filed: Oct. 12, 2006
(86) PCT No.: PCT/KR06/04097

§ 371 Date: Mar. 26, 2008

(30) Foreign Application Priority Data
Oct. 26, 2005 (KR) 10-2005-0101428
Sep. 27, 2006 (KR) 10-2006-0094134

(51) Int. Cl. H04L 9/32; G06F 21/00

(52) U.S. Cl. 726/7

(57) ABSTRACT

The present invention relates to a method and system for authenticating products using serial numbers and passwords over a network, which can determine whether the products are genuine based on the serial numbers, which are attached to the respective products, and the passwords, which can be viewed at the time of unsealing the products. When the present invention is used, authentication for a product is performed according to whether the serial number and password of the product match and whether a request for the authentication of the serial number has been made, and thus a reliable authentication system can be provided. Furthermore, one or more passwords for the product are sealed in or attached to the product, so that, if the password is not known, an imitation is distinguished as not being a genuine product, therefore an effective authentication system can be provided.

### TECHNICAL FIELD

The present invention relates, in general, to the authentication of products and, more particularly, to a method and system for authenticating products using serial numbers and passwords over a network, which can determine whether the products are genuine based on the serial numbers, which are attached to the respective products, and the passwords, which can be viewed at the time of unsealing the products.

### BACKGROUND ART

Methods of authenticating products at product-selling establishments, that is, the stores under direct management, fine article stores, department stores, shopping malls, and the like, include methods using the logo text, sewing designs, buckles and internal construction of the products, and also include methods of showing import licenses, and various tags and descriptions, which are used to determine whether products are genuine, when requests from purchasing costumers are made. However, products are being manufactured that are so similar that genuine products and imitations cannot be distinguished from each other using the above-described primitive methods, and it is becoming more and more difficult to distinguish genuine products from the imitations to that extent that a report that the imitations of various types of products are being sold even at duty-free shops and department stores has been released recently. Accordingly, in the method of authenticating products using marks, logos and the like, satisfactory results cannot be achieved due to the problem that, even though products are exquisitely and specially made, they can be imitated or forged.

Furthermore, from the manufacturer's point of view, problems occur in that products themselves or the image of the products are damaged because the scarcity and value of genuine products are decreased by the imitations, and in that the sales performance of the genuine products is lowered because the imitations can be purchased at a low price.

### DISCLOSURE

### Technical Problem

Accordingly, the present invention has been made keeping in mind the above problems occurring in the prior art, and an object of the present invention is to provide a method and system for authenticating products using serial numbers and passwords over a communication network, which perform an authentication procedure only for authenticated distributors, thus preventing illegal transactions or untaxed transactions, and allowing product manufacturers to distribute their products through desired channels.

Another object of the present invention is to provide a method and system, which, when a requester requests the authentication of a product using a terminal by inputting a serial number and a password attached to the product, determine whether the input serial number and password match previously registered data by checking the serial number and the password and whether an authentication request for the serial number has been made, and output a result value indicating that the requested product is genuine only if it is determined that the serial number and the password match the data and that no request to check the serial number has been made, thus authenticating the product.

A further object of the present invention is to provide a method and system for authenticating products, which, after a predetermined time has elapsed after the identification of the password, causes the corresponding password to disappear, thus preventing the duplicate use of the password.

Yet another object of the present invention is to provide a method and system for authenticating products, which allow a plurality of passwords to be registered, thus authenticating whether products are genuine so as to enable the sale of second-hand articles.

### Technical Solution

In order to accomplish the above objects, the present invention provides a method of authenticating products using serial numbers and passwords, the serial numbers and the passwords being received from requesters' terminals, the method including the steps of (a) receiving the serial number of a product from a requester's terminal; (b) receiving the password of the product from the requester's terminal; (c) determining whether the serial number and the password match data, which has been previously registered in a product authentication database, by checking the product authentication database for the serial number and the password, which has been received at steps (a) and (b); (d) if, as a result of the determination at step (c), it is determined that the serial number and the password match the data, determining whether a request to check the serial number has been made, and if it is determined that the serial number and the password do not match the data, providing an error message; (e) if, as a result of the determination at step (d), it is determined that no request to check the serial number has been made, outputting a result value indicating that the product having the serial number is genuine; and (f) if, as a result of the determination at step (d), it is determined that a request to check the serial number has been made, outputting a result value indicating that the product having the serial number is not genuine.

In addition, the present invention provides a system for authenticating products using serial numbers and passwords, the serial numbers and the passwords being received from requesters' terminals, the system including a product authentication server receiving the serial number and password of a product from a requester's terminal, determining whether the serial number and the password match previously registered data by checking for the serial number and the password, determining whether a request to check the serial number has been made if the serial number and the password match the data, providing an error message if it is determined that the serial number and the password do not match the data, outputting a result value indicating that the product having the serial number is genuine if it is determined that no request to check the serial number has been made, and outputting a result value indicating that the product having the serial number is not genuine if it is determined that a request to check the serial number has been made; and a product authentication database configured such that the password, associated with the serial number, has been previously registered as data, and information about whether the request to check the serial number has been made is stored therein.

According to an embodiment of the present invention, the password is sealed and attached to the product, is formed using volatile material, and is provided using a password sheet that is configured such that the password is volatized after a predetermined time has elapsed.

Furthermore, the password sheet includes a base sheet configured such that information about a password is printed thereon, a cadmium pattern configured such that a password is printed on the base sheet using a cadmium element, and an opening and closing sheet attached to the base sheet so as to protect the cadmium pattern from the air and allow a user to open and close the opening and closing sheet.

Furthermore, the disappearance time of the password printed on the cadmium pattern is set by adjusting the printing thickness of the cadmium pattern.

### DESCRIPTION OF DRAWINGS

FIG. 1 is a diagram schematically showing the construction of a system for authenticating products using serial numbers and passwords according to a preferred embodiment of the present invention;

FIG. 2 is a flowchart schematically illustrating a method of authenticating products using serial numbers and passwords according to a preferred embodiment of the present invention;

FIG. 3 is a flowchart illustrating an additional distributor authentication procedure for authenticating products using serial numbers and passwords according to a preferred embodiment of the present invention;

FIGS. 4a and 4b are diagrams illustrating a method of sealing passwords to authenticate products using serial numbers and passwords according to a preferred embodiment of the present invention; and

FIG. 5 is a diagram showing a structure in which a password is implemented using heat sensitive material.

### DESCRIPTION OF CHARACTERS OF PRINCIPAL ELEMENTS

110: mobile communication terminal
120: radio access network
122: base station transmitter
124: base station controller
130: MSC
132: HLR
134: VLR
136: billing server
140: gateway
142: wired and wireless Internet
144: product authentication server
146: product authentication database
401: base sheet
403: cadmium pattern
405: opening and closing sheet
407: opening and closing grip

### [Best Mode]

The preferred embodiments of the present invention are described in detail with reference to the accompanying drawings below. It should be noted that, when reference numerals are assigned to the respective components of the drawings, the same reference numerals are used throughout the different drawings to designate the same or similar components. Furthermore, in the description of the present invention, when it is determined that detailed descriptions of well-known constructions or functions are unnecessary and may make the gist of the present invention unclear, such detailed descriptions will be omitted.

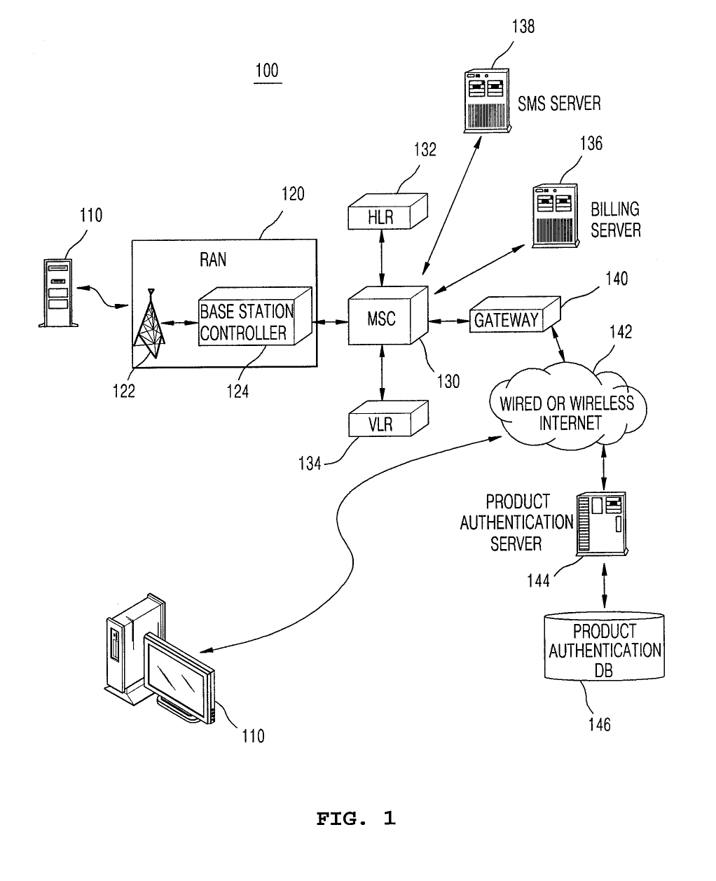

FIG. 1 is a diagram schematically showing the construction of a system for authenticating products using serial numbers and passwords according to a preferred embodiment of the present invention.

The system for authenticating products using serial numbers and passwords according to a preferred embodiment of the present invention may include a requester's terminal 110, a Radio Access Network (RAN) 120, a Mobile Switching Center (MSC) 130, a Home Location Register (HRL) 132, a Visitor Location Register (VLR) 134, a billing server 136, a Short Message Service (SMS) server 138, a gateway 140, a wired and wireless Internet 142, a product authentication server 144, and a product authentication database 146.

The term ‘product authentication service’, according to the technical spirit of the present invention, is a service of authenticating products in such a way that, when a requester makes a request to check a serial number and a password, which are attached to a product, using the requester's terminal 110, the product authentication server 144 determines whether the serial number and the password match previously registered data by checking the serial number and the password and whether a request to check the serial number has been made, and outputs a result value indicating that the requested product is genuine to the requester's terminal 110 only if it is determined that the serial number and the password match the data and that no request to check the serial number has been made. A detailed process for the above-described service will be described in detail later.

The requester's terminal 110 according to a preferred embodiment of the present invention is a communication terminal, such as a computer, a mobile communication terminal or a Personal Digital Assistant (PDA), that enables the wired or wireless Internet, and is provided with a specific web browser to use the wired or wireless Internet. The web browser performing the above-described function may be Internet Explorer, Netscape Communicator or the like. Furthermore, a dedicated client program, other than a conventional wired or wireless Internet browser such as Internet Explorer or Netscape Communicator, may be additionally installed and implemented in the user's terminal 110.

In particular, the mobile communication terminal is a terminal that can perform voice and/or video communication and data communication with the other party via a communication network. In order to perform wireless Internet service using the terminal, a virtual machine using Java must generally be installed therein. Java is characterized in that, compared to other existing programming languages, it has high portability because the coding of programs is simple, a distributed networking environment is supported, security is excellent, and operation thereof is possible regardless of systems. Meanwhile, in order to use the product authentication service using the requester's terminal 110, an application for the use of service and registration for a subscriber to the product authentication service must additionally be made, and a specific web browser must be installed therein. In this case, it is preferred that registration as a service subscriber be made through a distributor.

The requester's terminal 110 according to the preferred embodiment of the present invention functions to receive the serial numbers and passwords of products, which are input by requesters, and transmit the received serial numbers and passwords to the product authentication server 144 via the wired and wireless Internet 142. In this case, the received passwords of the products are arbitrary numbers assigned to serial numbers at random. The passwords corresponding to the serial numbers may be information that is handled only by product manufacturers, and differ from each other for respective serial numbers.

The RAN 120 according to a preferred embodiment of the present invention is a ground infrastructure that functions to assure the mobility of the requester's terminal 110, and performs handoff and wireless supporting management functions. The RAN 120 includes a base station transmitter 122 and a base station controller 124, and supports both synchronous and asynchronous modes. In the synchronous mode, the base station transmitter 122 may be a Base Transceiver Station (BTS), and the base station controller 124 may be a Base Station Controller (BSC). In the asynchronous mode, the base station transmitter 122 may be a Radio Transceiver Subsystem (RTS), and the base station controller 124 may be a Radio Network Controller (RNC). Here, the RAN 120 according to the preferred embodiment of the present invention is not limited thereto, but also includes a Global System for Mobile communications (GSM) network, and the access network of a fourth generation mobile communication system that will be implemented in the future, rather than a CDMA network, and may also be applied to a wired telephone network.

The base station transmitter 122 according to an embodiment of the present invention receives a call request signal from the requester's terminal 110 through a traffic channel, which is one signal channel, and transmits the received call request signal to the base station controller 124. Furthermore, the base station transmitter 122 is a network endpoint device that is directly connected with the requester's terminal 110 by performing base band signal processing, wired and wireless conversion, and the transmission and reception of a wireless signal.

The base station controller 124 according to an embodiment of the present invention controls the base station transmitter 122, and performs functions, such as the assigning and cancellation of a wireless channel for the requester's terminal 110, the controlling of the transmission output of the requester's terminal 110 and the base station transmitter 122, the determination of soft handoff and hard handoff between cells, transcoding and vocoding, clock distribution for a Global Positioning System (GPS), and the operation and maintenance for a base station. The base station controller 124 transmits the call request signal, which has been received through the base station transmitter 122, to the MSC 130.

The MSC 130 according to a preferred embodiment of the present invention performs functions, such as the processing of basic and additional services, the processing of subscribers' reception and transmission calls, and the processing of location registration and handoff procedures, and operates in conjunction with other networks. The MSC 130 of an IS-95 A/B/C system includes subsystems, such as an Access Switching Subsystem (ASS) for performing a distributed call processing function, and an Interconnection Network Subsystem (INS) for performing a concentrated call processing function, a Central Control Subsystem (CCS) for performing an operation and maintenance concentration function, and a Location Registration Subsystem (LRS) for performing a function of storing and managing information about mobile subscribers LRS.

Furthermore, an Asynchronous Transfer Mode (ATM) switch (not shown) may be included in the MSC 130 for third generation and fourth generation systems. The ATM switch increases the transmission rate and the efficiency of use of lines by transmitting packets on a cell basis.

The HLR 132 according to an embodiment of the present invention receives information about the locations of terminals from the VLR 134, and performs functions, such as registration detection, registration deletion, and location determination. Furthermore, information about the profile of the requester's terminal 110 is stored in the HLR 132. In this case, the profile information refers to information about the Mobile Identification Number (MIM), Electronic Serial Number and/or entered mobile communication service (ESM) of the requester's terminal 110.

The VLR 134 according to an embodiment of the present invention receives information about the locations of visiting subscribers, which have been registered, from the MSC 130 and stores the information. In the case of the reception and transmission of the requester's terminal 110, the VLR 134 receives data about subscribers from the MSC 130 and stores the information.

The billing server 136 according to an embodiment of the present invention operates in conjunction with a customer management server (not shown) in which subscribers' personal information, such as names, resident registration numbers, telephone numbers and passwords, a fee scheme for the subscribers, information about service, such as the interruption of transmission or the cancellation of transmission interruption, and the details of use of service are stored. In this case, the service may include telephone call service using the requester's terminal 110, wireless Internet service, and SMS. When the subscribers use the telephone call service, the wireless Internet service and the SMS, the billing server 136 functions to calculate fees based on the time of use of the service or the amount of transmitted and received data. In this case, a method of paying a fee based on the amount of transmitted and received data is generally applied to a packet data communication system.

In particular, when the product authentication service according to a preferred embodiment of the present invention is used, the product authentication server 144 may transmit the results of product authentication and supplementary information to the requester's terminal 110 in SMS form. In this case, the fee for the use of the service is managed by the billing server 136, and the billing server 136 may charge a product manufacturer or the requester's terminal 110 for the fee.

When receiving a request for the transmission of a short message, which is made to the requester's terminal 110, from the product authentication server 144, which will be described later, the SMS server 138 according to an embodiment of the present invention transmits the short message and a return telephone number to the corresponding requester's terminal 110 via the mobile communication network.

The gateway 140 according to an embodiment of the present invention has an Inter-Working Function (IWF), which is currently being used in mobile communication systems, and performs switching on a cell basis using both of circuit and data lines to process packet data directly accessed on a cell basis. The gateway 140 performs a function of connection with other networks, such as a Public Switched Telephone Network (PSTN), a Public Switched Data Network (PSDN), an Integrated Services Digital Network (ISDN), a Broadband ISDN (B-ISDN), an Intelligent Network (IN) and a Public Land Mobile Network (PLMN).

Meanwhile, a Wireless Application Protocol (WAP) gateway may also be included in the gateway 140. In order to allow the requester's terminal 110, in which a WAP browser is installed, to be connected to the product authentication server 146, the WAP gateway and the wired and wireless Internet 142 are passed through. In this case, the WAP gateway receives a request for Internet service depending on WAP from the requester's terminal 110, and performs conversion on the request using Transmission Control Protocol/Internet Protocol (TCP/IP), and transmits the results of the conversion to the product authentication server 144. Conversely, the WAP gateway receives response data depending on the TCP/IP from the product authentication server 144, performs conversion on the response data, and transmits the results of the conversion to the requester's terminal 110.

The product authentication server 144 according to an embodiment of the present invention functions to receive a request for product authentication service from the requester's terminal 110 via the mobile communication network or the wired and wireless Internet network, and process the request. That is, the product authentication server 144 functions to provide the screen of a web site for product authentication service to the requester's terminal 110, generate and store the results of product authentication and supplementary information, and transmit them to the requester's terminal 110.

The product authentication server 144 according to the embodiment of the present invention receives the serial number and password of a product from the requester's terminal 110, and determines whether the received serial number and password match previously registered data by checking a product authentication database 146, which will be described later. If the received serial number and password match the data, the product authentication server 144 determines whether a request to check the received serial number has been made by checking the product authentication database 146, and outputs a result value indicating that the product having the received serial number is genuine only if it is determined that no request to check the serial number has been made. If it is determined that a request to check the serial number has been made, the product authentication server 144 outputs a result value indicating that the product having the received serial number is not genuine, thus performing a function of determining whether products are genuine.

That is, the authentication of the product is primarily performed using a method of matching the serial number and the password, information about whether the serial number and the password have been checked in the past is managed, and the product is determined to be an imitation if the serial number and the password have been checked in the past even if they match the data.

In a preferred embodiment of the present invention, the nation in which a product is to be sold and whether the product is for home or for business use, instead of the output value about whether the product is genuine, are managed and provided using serial numbers, so that the present invention can be used for the collection of taxes and the prevention of smuggling.

As described above, in the product authentication server 144 according to the embodiment of the present invention, authentication for a product is performed using information about whether the serial number and password of the product have been checked in the past, therefore it is necessary to protect the password so that a forger cannot first make a request to check the serial number and password. If the password of a product for which authentication procedure is not performed by the present authentication system continues to remain, the forger can view the password and, thus, can manufacture a forgery.

Accordingly, in a preferred embodiment of the present invention, a password is attached to a product and is then sealed. The password is formed using volatile material, so that, when unsealed, it volatizes after a predetermined time has elapsed. In this case, the password may be volatized according to the amount of detected light, or may be volatized by being processed using a volatile chemical. Furthermore, in the case where the product is an alcoholic beverage introduced to Korea from the West, a process of recording a password inside the lid of the alcoholic beverage bottle and then allowing the password to disappear when the concentration of alcohol in the air is lowered to less than a predetermined level is performed, so that the password can be protected.

For example, the password may be recorded using heat-sensitive material that can be visible depending on the pressure and temperature in the bottle. The heat-sensitive material may be visible at a predetermined temperature or higher or may be visible below a predetermined temperature. Accordingly, when the lid of a bottle is opened in a state in which a password is recorded using the above-described heat-sensitive material, the password is visible. Thereafter, when alcohol adhering to the inside of the lid of the bottle evaporates after the predetermined time has elapsed, variations in temperature and pressure due to the evaporation of the alcohol occur. The variations in temperature and pressure cause the inversion of the heat-sensitive material such that the heat-sensitive material becomes transparent, therefore the password cannot be viewed.

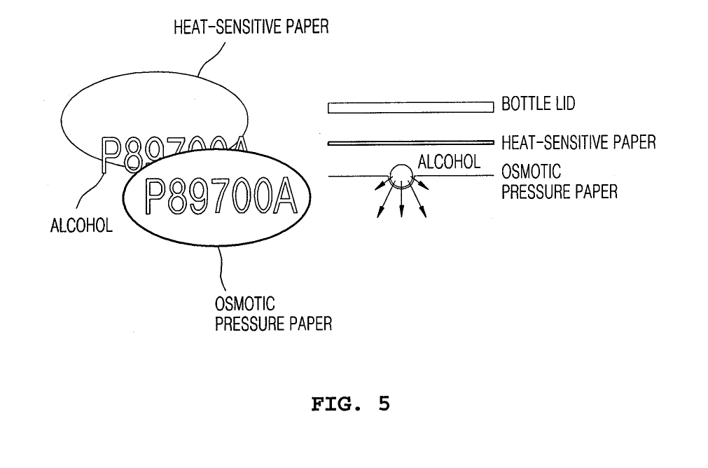

FIG. 5 is a diagram showing a structure in which a password is implemented using heat sensitive material. As shown in the drawing, heat-sensitive paper is attached to the bottom of a bottle lid, and osmotic pressure paper is attached to the heat-sensitive paper. Alcohol is injected between the osmotic pressure paper and the heat-sensitive paper. In this case, the alcohol is injected to have a shape corresponding to a password. That is, a space for injecting alcohol is formed by pressing the osmotic pressure paper over the shape corresponding to a password. Thereafter, the osmotic pressure paper is wet by the alcohol and is then attached to the heat-sensitive paper. The alcohol injection space is very minute, so that, when the alcohol present in the corresponding space evaporates, the osmotic pressure paper comes into contact with the heat-sensitive paper. Accordingly, alcohol cannot be injected again into the osmotic pressure paper from which the former alcohol has evaporated, so that the password due to the deformation of the above-described space cannot be formed again even if alcohol is injected again.

In the password manufactured as described above, the alcohol present in the osmotic pressure paper does not evaporate due to pressure in the bottle and the water content of the alcohol. Thereafter, when the user opens the lid of the bottle, the heat-sensitive paper, which has been set to corresponding pressure and temperature, temporarily exhibits a color. The reason for this is because the alcohol present on the surface of the osmotic pressure paper evaporates and, thereby, the temperature of the surface of the heat-sensitive paper varies. A heat-sensitive color is realized in the remaining portion, other than the alcohol text (password), within the osmotic pressure paper. Accordingly, variation in color does not occur in the current alcohol text portion, from which the alcohol has not evaporated, so that the alcohol text can be visually distinguished. Thereafter, the internal pressure in the lid of the bottle decreases to atmospheric pressure. Thereafter, the alcohol present in the osmotic pressure paper slowly evaporates in the air, so that the portion of the heat-sensitive paper corresponding to the alcohol text (password) turns to the surrounding color, therefore the alcohol text cannot be identified. As a result, after a predetermined time has elapsed after the opening of the lid of the bottle, the password visible in the lid of the bottle disappears. Thereafter, even if alcohol is injected into the lid of the bottle again, the osmotic pressure paper varies internally, and thus the alcohol text cannot be viewed.

That is, when the alcohol present in the osmotic pressure paper evaporates entirely, contraction of the alcohol injection space occurs, so that the alcohol injection space is deformed, therefore the alcohol text cannot be viewed.

Meanwhile, the product authentication database 146 according to the preferred embodiment of the present invention includes the serial number of an arbitrary product and a password associated with the serial number, which have been registered as data, and also stores information about whether a request to check the serial number has been made.

The product authentication database 146 may be implemented to be suitable for the purpose of the present invention using a Relational DataBase Management System (RDBMS), such as Oracle, Informix, Sybase or DB2, an Object-Oriented Database Management System (OODBMS), such as Gemston, Orion or O2, or an XML native database, such as Excelon, Tamino or Sekaiju, and has an appropriate field or element to achieve its own function.

Since the establishment and management of a database necessary for the present invention may be easily realized by those having ordinary skill in the art to which the present invention pertains, a detailed description thereof is omitted.

Meanwhile, although, in the above description, the wired or wireless Internet has been described as being used for the method of making a request to check a serial number and a password and receiving the results of the request, the present invention is not limited thereto. That is, an existing wired telephone network may be used, or a dedicated terminal, such as a card reader, may be used. Furthermore, a serial number may be read through the dedicated terminal using a bar code, which has been attached to a product, or Radio Frequency Identification (RFID), without inputting the serial number. That is, it will be apparent that all of the methods used as authentication means are understood as being included in the scope of the present invention as long as any request to check serial numbers and passwords can be made.

Furthermore, in the present invention, for the cases where fine articles are sold as second-hand products, the password according to the preferred embodiment of the present invention may be managed in a dual or triple manner. That is, when a first purchaser sells a second-hand product to a second purchaser, the product authentication database 146 according to the preferred embodiment of the present invention is updated and a new password is assigned to the second-hand product. Accordingly, even for second-hand products, whether the products are genuine can be accurately determined.

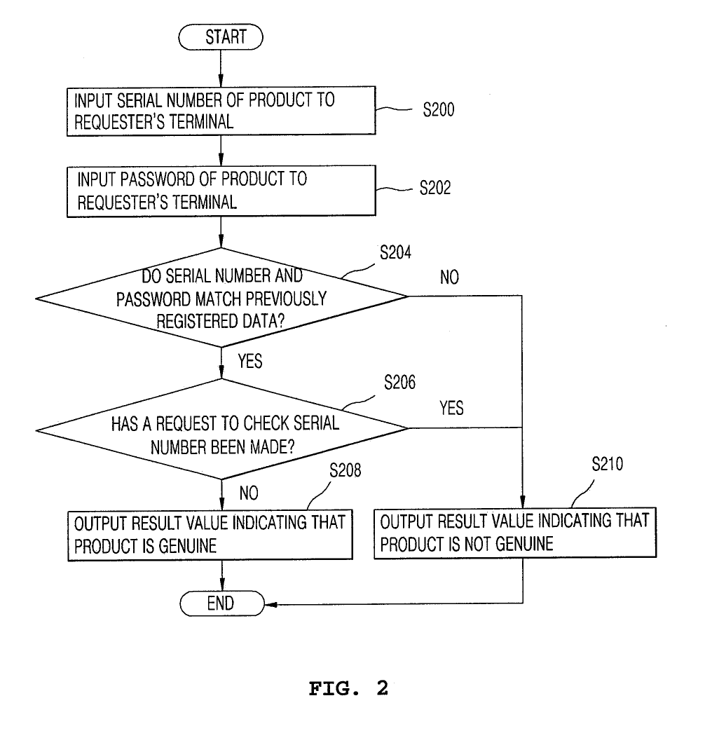

FIG. 2 is a flowchart schematically illustrating a method of authenticating products using serial numbers and passwords according to a preferred embodiment of the present invention.

First, a requester, who desires to make a request about whether a product is genuine, inputs the serial number and password of the product using the requester's terminal 110 at steps S200 and S202. The input serial number and the password are transmitted to the product authentication server 144 according to the preferred embodiment of the present invention. As described above, the input and transmission of the serial number and the password may be performed using a wired and wireless system or a dedicated terminal.

The product authentication server 144, which has received the serial number and the password from the requester's terminal 110, determines whether the received serial number and password match previously registered data by checking the product authentication database 146 at step S204. If it is determined that the received serial number and password match the data, the product authentication server 144 determines whether a request to check the serial number has been made by checking the product authentication database 146 again at step S206.

If, as a result of the determination, it is determined that no request to check the serial number has been made, a result value indicating that the concerned product having the serial number is genuine is output at step S208. In contrast, if it is determined that a request to check the serial number has been made, a result value indicating that the concerned product having the serial number is not genuine is output at step S210.

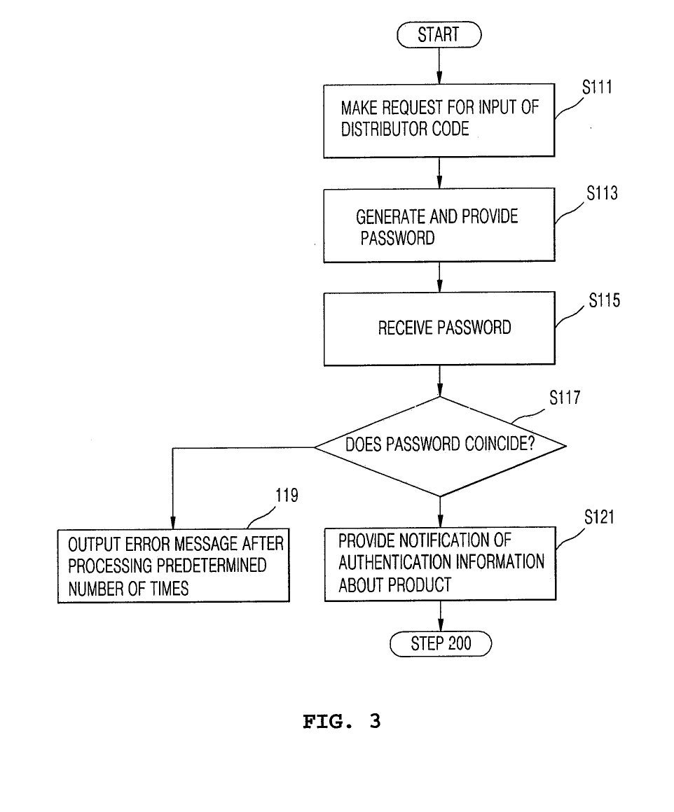

Meanwhile, in an embodiment of the present invention, some other procedure for increasing the reliability of authentication may be added. For example, after the serial number and the password, described above, have been input at the initial step, a request to input a distributor code may be made, and a request to generate a password based on the distributor code and input the password may be made. That is, as shown in FIG. 3, the product authentication server 144 requests the input of the distributor code from the requester's terminal 110 at step S110.

The input of the distributor code is performed to determine whether the distributor is licensed, and is performed to prevent the password of the corresponding product from being correctly guessed by chance upon a random attempt at authentication. The code may be the business number or registration number of the corresponding distributor. If the code is replaced with the phone number of the corresponding distributor or a terminal number, this does not represent a departure from the gist of the present invention. Thereafter, the product authentication server 144 generates and stores a password obtained by the generation of random numbers at step S113. The password is generated using a random number algorithm. Thereafter, the product authentication server 144 provides the generated password to the registered terminal of the distributor, and requests the input of the corresponding password from the requester at step S115.

The product authentication server 144 determines whether a currently input password is the same as the password generated by the random algorithm at step S117. If, as a result of the determination, the password input by the requester is found not to be the same as the password generated by the random number algorithm, the product authentication server 144 returns to step S119 to perform error processing. This error processing can be requested to be performed a predetermined number of times or more.

In contrast, if the password input by the requester is the same as the password generated by the random number algorithm, the product authentication server 144 provides authentication information about the product that the user desires to purchase at step S121.

As the distributor is requested to input the password as described above, unauthorized distributors cannot sell their products, and thus untaxed transactions can be additionally prevented.

Although, at step S110, the present embodiment receives a distributor code and generates a password, another embodiment may be implemented such that the phone number of a user who additionally requests the authentication of a product is received and the input of a password is directly requested from the user at a step after the authentication of the distributor. That is, the product authentication requester (user) is requested to input a telephone number that enables the reception of a password. A new telephone number, or a terminal telephone number, which is currently used while a request for product authentication is made, may be input. Thereafter, the product authentication server 144 generates a password using a random number algorithm based on the user's telephone number. The password is directly transmitted to the user, and prompts to input the corresponding password are provided to the user.

In the same manner, the subsequent step cannot be performed if the password does not coincide in the present procedure, and a message for providing notification of the fact that the corresponding product is genuine is provided if the password coincides. As required, the product authentication procedure may be terminated after an error for the password has occurred a predetermined number of times, for example, two times. In contrast, when the password is authenticated and the process proceeds to the subsequent step, the terminal number that has been used to receive the password is stored in the product authentication database and may be used for authentication when a second-hand product is sold later.

The authentication system according to the present invention may be applied to all products, such as various types of alcoholic drinks, including alcoholic beverages introduced to Korea from the West, beverages, clothes, bags and shoes, for which it is necessary to determine whether the products are genuine. However, for alcoholic drinks or beverages, passwords can be viewed only when the lids of thereof have been opened, so that the probability of first making a request to check a forgery is very low, therefore negative replies that denounce original products as forgeries will not be made. For other products, passwords can be viewed regardless whether the products have been opened (that is, whether the products have been purchased), so that negative replies stating that the products are not genuine may be made if a forger first makes requests to check the products.

Such a flaw may be very critical, so a method of covering a password, that is, a method of sealing a password, should be used. This sealing method is realized such that the password cannot be sealed again once the password is unsealed, and the value of a product is reduced as soon as the password is unsealed. That is, a method of causing a password to disappear after a predetermined time has elapsed after the unsealing of the password may be used later.

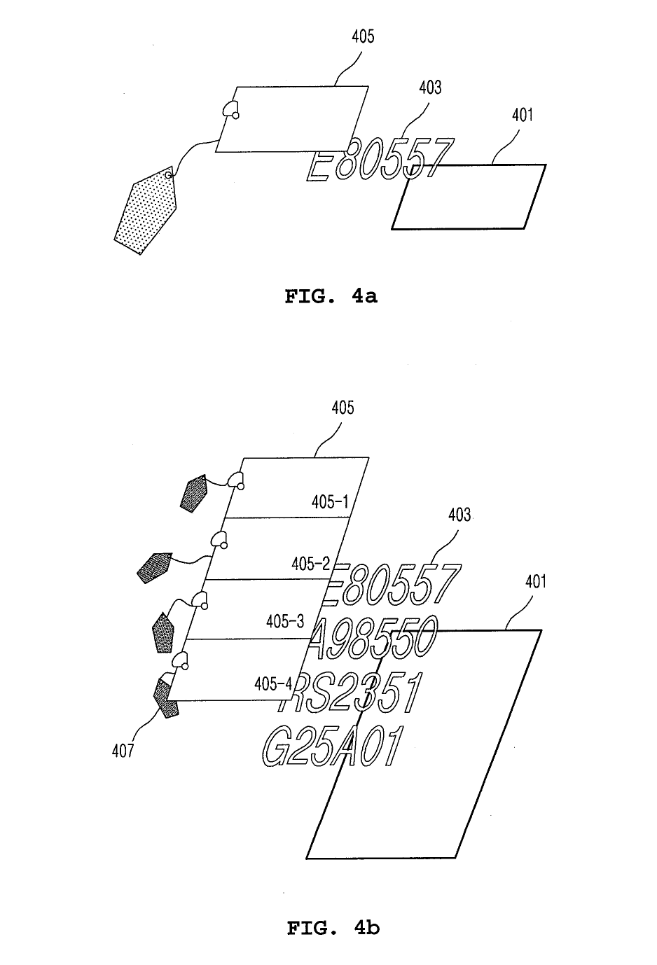

The method of sealing a password, described above, may be realized using a material that easily oxidizes in the air. That is, as shown in FIG. 4a, a password sheet includes a base sheet 401 configured such that information about a password is printed thereon, a cadmium pattern 403 configured such a password is printed on the base sheet 401 using a cadmium (cd) device, and an opening and closing sheet 405 attached to the base sheet 401 to protect the cadmium pattern 403 from the air and allow a user to open and close it.

In this case, a purpose of using the cadmium material is for using a characteristic in which the surface thereof is oxidized in the air, and the cadmium material uses remaining materials, which are created from flue dust generated at the time of refining zinc, extraction using a wet method, and a purifying process for a zinc solution, as raw materials. In this case, the content of cadmium ranges from several % to several tens of %. The cadmium is extracted using sulfuric acid, is replaced with zinc and deposited, and is manufactured to be in a sponge state. Thereafter, the resultant product is dissolved into an electrolytic solution, and is electrolyzed and molded.

The above-described cadmium is thinly printed on a base sheet 401, and information about a random number is recorded thereon. It is preferred that the cadmium pattern 403 be printed on a base sheet 401 in the vacuum state. After the cadmium pattern 403 is printed, the opening and closing sheet 405 is attached to the top of the cadmium pattern 403. The opening and closing sheet 405 is easily attachably detached, and the cadmium material of the cadmium pattern 403 is exposed to the air at the time that the sheet is detached.

The cadmium material is oxidized when it is exposed to the air, and the oxidation rate is proportional to the printing thickness of the cadmium pattern 403. For example, the cadmium pattern 403 may be printed to a thickness of 20 nm so that the password can be viewed for about one minute in the state in which the opening and closing sheet 405 is opened, or may be printed to a thickness of 80 nm on the opening and closing sheet 405 to allow the password to be exposed for about one hour in the state in which the opening and closing sheet 405 is opened.

In this case, the cadmium pattern 403 has a specific added color, so that it is distinguishable from the base sheet 401, therefore the user can be aware of the encrypted information. The encrypted information may be numeric or text information. Furthermore, an opening and closing grip 407 may be installed on the opening and closing sheet 405 so that it is easily opened and closed by the user. The opening and closing sheet 405 is made of an opaque material.

Accordingly, when a request for a password from the product authentication server 144 is made to determine whether a product is genuine, the user opens the opening and closing sheet 405. This opening and closing sheet 405 is made of an opaque material, so that the password recorded on the cadmium pattern 403 cannot be viewed. The user can view the cadmium pattern 403 printed on the base sheet 401 when the opening and closing sheet 405 has been opened at the request of the product authentication server 144. The cadmium pattern 403 has information about the password. The user notifies the password, which is recorded on the cadmium pattern 403, of the product authentication server 144, thus receiving a result about whether a corresponding product is genuine.

Thereafter, as the opening and closing sheet 405 is opened, the cadmium pattern 403 is exposed to the air and the air oxidizes the cadmium pattern 403. Since the oxidation rate of the cadmium pattern is proportional to the printing thickness of the cadmium pattern as described above, the manufacturer can adjust the exposure time of the password. That is, the password is exposed to the air for one minute and is oxidized, and thus it disappears. Accordingly, after a predetermined time has elapsed after the user has viewed the password, the password disappears.

Meanwhile, in the case where fine articles are sold as second-hand products, the password may be managed in a dual or triple manner. That is, a plurality of passwords is recorded as shown in FIG. 4b, so that, when a first purchaser sells a product to a second purchaser, whether the product is genuine can be determined through the authentication of a second password. In this case, information about the sequential position of the password is identified and is then made known to the product authentication server 144. Furthermore, in the cases where fine articles are sold as second-hand products, the number of a purchaser's terminal, notification of the password of which has been provided to the previous purchaser, instead of the above-described distributor code, may be input. That is, in the case where the terminal number, which has been used when the previous purchaser conducts authentication for his or her product, is ‘xxxx,’ a message indicating that a password has been sent again based on the number and thus must be input, so that the procedure for delivering the fine article can be clarified. As required, the name or detailed personal information of the previous purchaser may also be provided.

For example, when a purchaser, who has purchased a fine article for the first time, desires to sell it to a second purchaser, the first purchaser opens the opening and closing sheet 405 corresponding to reference numeral 405-1. The first purchaser views ‘E80557,’ which corresponds to the first password, and checks whether the product is genuine using the corresponding password. Furthermore, when the first purchaser sells the product to the second purchaser, the second purchaser opens the opening and closing sheet 405 corresponding to reference numeral 405-2, and views ‘A98550,’ which is a second password. Thereafter, whether the product is genuine is checked using the corresponding password. Accordingly, a plurality of passwords may be needed according to the type of products.

The above description is only an illustrative description for the present invention, and those having ordinary skill in the art to which the present invention pertains may make modifications in various ways in a range within which the intrinsic characteristics of the present invention do not depart. Accordingly, the embodiments disclosed in the present specification have been described for the description of the present invention, rather than for the limitation thereof, and the spirit and scope of the present invention are not limited by the embodiments. The scope of the present invention must be interpreted based on the following claims, and all of the technologies within a range equivalent to the present invention should be interpreted as being included in the scope of the present invention.

### INDUSTRIAL APPLICABILITY

When the present invention is used, authentication for a product is performed according to whether the serial number and password of the product notch and whether a request for the authentication of the serial number has been made, and thus a reliable authentication system can be provided. Furthermore, one or more passwords for the product are sealed in or attached to the product, so that, if the password is not known, an imitation is distinguished as not being a genuine product, therefore an effective authentication system can be provided.

1. A method of authenticating products using serial numbers and passwords, the serial numbers and the passwords being received from requesters' terminals, the method comprising the steps of:
(a) receiving a serial number of a product from a requester's terminal;
(b) receiving a password of the product from the requester's terminal;
(c) determining whether the serial number and the password match data, which has been previously registered in a product authentication database, by checking the product authentication database for the serial number and the password, which has been received at steps (a) and (b);
(d) if, as a result of the determination at step (c), it is determined that the serial number and the password match the data, determining whether a request to check the serial number has been made, and if it is determined that the serial number and the password do not match the data, providing an error message;
(e) if, as a result of the determination at step (d), it is determined that no request to check the serial number has been made, outputting a result value indicating that the product having the serial number is genuine; and
(f) if, as a result of the determination at step (d), it is determined that a request to check the serial number has been made, outputting a result value indicating that the product having the serial number is not genuine.

2. The method according to claim 1, wherein the password is recorded in the product.

3. The method according to claim 2, wherein the password is sealed and attached to the product, is formed using volatile material, and is provided using a password sheet that is configured such that the password is volatized after a predetermined time has elapsed.

4. The method according to claim 3, wherein:
the password sheet comprises two or more sheets; and
the password is registered on each of the password sheets.

5. The method according to claim 3, wherein the password sheet is configured in such a way that alcohol is injected between heat-sensitive paper and osmotic pressure paper, and a shape corresponding to the password is formed using the alcohol.

6. A system for authenticating products using serial numbers and passwords, the serial numbers and the passwords being received from requesters' terminals, the system comprising:
a product authentication server receiving a serial number and password of a product from a requester's terminal, determining whether the serial number and the password match previously registered data by checking for the serial number and the password, determining whether a request to check the serial number has been made if the serial number and the password match the data, providing an error message if it is determined that the serial number and the password do not match the data, outputting a result value indicating that the product having the serial number is genuine if it is determined that no request to check the serial number has been made, and outputting a result value indicating that the product having the serial number is not genuine if it is determined that a request to check the serial number has been made; and
a product authentication database configured such that the password, associated with the serial number, has been previously registered as data, and information about whether the request to check the serial number has been made is stored therein.

7. The system according to claim 6, wherein the password is recorded in the product.

8. The system according to claim 6, wherein the password is sealed and attached to the product, is formed using volatile material, and is provided using a password sheet that is configured such that the password volatizes after a predetermined time has elapsed.

9. The system according to claim 8, wherein the password sheet comprises a base sheet configured such that information about a password is printed thereon, a cadmium pattern configured such that a password is printed on the base sheet using a cadmium element, and an opening and closing sheet attached to the base sheet so as to protect the cadmium pattern from the air and allow a user to open and close the opening and closing sheet.

10. The system according to claim 8 or 9, wherein:
the password sheet comprises two or more sheets; and
the password is recorded on each of the password sheets.

11. The system according to claim 8 or 9, wherein the password sheet is configured such that a disappearance time of the password printed on the cadmium pattern is set by adjusting a printing thickness of the cadmium pattern.

12. The system according to claim 8 or 9, wherein the cadmium pattern has a specific added color, so that the cadmium pattern is distinguished from the base sheet and, therefore, a user can be aware of encrypted information.

13. The system according to claim 8 or 9, wherein the opening and closing sheet is made of opaque material.

14. The system according to claim 8 or 9, wherein the opening and closing sheet is configured such that an opening and closing grip is installed thereon so as to allow a user to easily open and close the opening and closing sheet.

15. The system according to claim 8, wherein the password sheet is configured in such a way that alcohol is injected between heat-sensitive paper and osmotic pressure paper, and a shape corresponding to the password is formed using the alcohol.
